(19) United States
(12) Patent Application Publication
(10) Pub. No.: US 2002/0046133 A1
(43) Pub. Date: Apr. 18, 2002

(54) Method for treating permeable surface items according to item owner's instructions

(76) Inventor: Uday Narendra Sheth, Cincinnati, OH (US)

Correspondence Address: THE PROCTER & GAMBLE COMPANY, PATENT DIVISION, MIAMI VALLEY LABORATORIES, P.O. BOX 538707, CINCINNATI, OH, 45253-8707, US

(21) Appl. No.: 09/963,822

(22) Filed: Sep. 26, 2001

Related U.S. Application Data
(60) Provisional application No. 60/249,146, filed on Nov. 16, 2000.
(60) Provisional application No. 60/236,116, filed on Sep. 28, 2000.

(51) Int. Cl. G06F 17/60; B05D 1/00; D06F 1/00; D06L 1/00

(52) U.S. Cl. 705/26; 427/8; 8/137

(57) ABSTRACT

The present invention relates to a method for having permeable surface items treated according to the item owner's instructions and personal preferences. More particularly, the present invention relates to a method for treating permeable surface items by transmitting instructions and personal preferences to a service provider such that the service provider treats the items in the directed manner. The present invention also relates to a system for treating permeable surface items according to the item owner's instructions and personal preferences that includes a way for the item owner to transmit instructions and personal preferences to a service provider so that the service provider treats the items in the directed manner.

### RELATED APPLICATIONS

This application claims priority under 35 U.S.C. §119(e) to U.S. Provisional Application Serial No. 60/249,146 filed Nov. 16, 2000 and to U.S. Provisional Application Serial No. 60/236,116 filed Sep. 28, 2000.

### FIELD OF THE INVENTION

The present invention relates to a method for having permeable surface items treated according to the item owner's instructions and personal preferences. More particularly, the present invention relates to a method for treating permeable surface items by transmitting instructions and personal preferences to a service provider such that the service provider treats the items in the directed manner. The present invention also relates to a system for treating permeable surface items according to the item owner's instructions and personal preferences that includes a way for the item owner to transmit instructions and personal preferences to a service provider so that the service provider treats the items in the directed manner.

### BACKGROUND OF THE INVENTION

In today's rapid moving and hectic society, more and more people are finding less time to relax and do the things they enjoy. As a result, people are constantly in search of ways to reduce any unnecessary work by farming it out to service providers. A typical person can spend several hours a week laundering and pressing their clothing. Further, this person must still take delicate items to the dry-cleaner if the item is in need of cleaning or spot removal. Caring for one's fabric, textile, and leather items can be a time-consuming process that is incapable of being farmed out since most people require these items to be cared for in a special manner.

Conventional laundry and dry-cleaning services have been available for many years. Typically, a customer delivers garments in need of cleaning and/or pressing to the dry-cleaner or launderer and picks the garments up in one to three days. The dry-cleaner's service offerings include cleaning, spot removal, starching, and pressing. The finished garments are typically hung on hangers or folded. The dry-cleaner's services do not offer room for customization other than final starch levels and delivery form (hung or folded).

The launderer's service offerings are even more limited. The launderer typically washes all of the garments in one laundry detergent, folds them, and packages them in a plastic bag. Fabric softening is typically not performed and the items are often folded in a sloppy manner. In either case, the customer is expected to pick-up and drop off their garments. This requires scheduling for trips to and from the cleaners and/or laundry service storefront. Further, neither the dry-cleaner nor launderer offers a full range of services including fabric, textile, and leather care for coats and shoes.

Accordingly, there is a need to provide an all-inclusive fabric, textile, and leather care service that provides a high degree of customization for individual needs while requiring minimum involvement on the consumer's part.

### SUMMARY OF THE INVENTION

The present invention fulfills the needs identified above by providing a method of treating all fabric, textile, and leather items in a highly customizable manner with little or no involvement on the part of the customer. Once the customer transmits their specific instructions and personal preferences to the service provider, the customer can relax as their laundry and dry-clean items are picked up at a desired time from a desired place, treated by the service provider, in the exact manner they requested, and dropped off at a desired time and at a desired place.

One aspect of the present invention is a method for treating permeable surface items according to item owner's instructions and personal preferences comprising transmitting said instructions and personal preferences for said permeable surface items to a service provider such that said service provider treats said permeable surface items according to item owner's instructions and personal preferences.

Yet another aspect of the present invention is a system for treating permeable surface items according to the item owner's instructions and personal preferences comprising a means for the item owner to transmit said instructions and personal preferences for said permeable surface items to a service provider such that said service provider treats said permeable surface items according to item owner's instructions and personal preferences.

Accordingly, the present invention provides a method for treating fabric, textile, and leather items in a highly customizable manner with little or no intervention on the part of the customer.

These and other aspects, objects, features and advantages will be clear from the following detailed description, examples and appended claims.

### DETAILED DESCRIPTION OF THE INVENTION

Items to be treated

The method described herein is directed to a wide variety of permeable surface items such as laundry, dry-clean, and leather items. These items can include wearable and non-wearable items. Wearable items can include shirts, blouses, pants, skirts, suits, dresses, sweaters, jeans, coats, jackets, blazers, under garments, socks, hosiery, shoes, and other items worn on the person. Non-wearable items can include beach towels, bath towels, hand towels, washcloths, bathrobes, bed sheets, pillowcases, bed covers, mattress pads, pillows, comforters, blankets, curtains, draperies, and dining table linens.

All of the aforementioned items may be constructed from a wide variety of materials including cotton, polyester, nylon, rayon, silk, wool, spandex, leather, canvas, natural fur, synthetic fur and mixtures or combinations thereof. Other items and construction materials will be apparent to the customer, dry-cleaning professional, and laundry professional.

Means for Transmitting

The method described herein requires transmission of a customer's specific laundry and dry-clean instructions to a service provider requesting the service provider to provide a service. Preferably, this means is discrete or separate from the service provider in that the customer's interface need not be installed, funded, or controlled by the service provider. For comparison, U.S. Pat. No. 4,803,348 describes a system for communication of general instructions that is not discreet from the service provider, and is hereby incorporated by reference. This neutral transmission means can be telephone line, local access network line, television cable line, satellite, computer, Internet, telecommunications device, electronic mail, and/or letter mail.

Further, the means for transmission can enable communication in two ways. The consumer may communicate specific instructions to the item to be treated, which, in turn, communicates the same to the service provider or its facilities or its computers. PCT International Publication WO 97/10376 describes some item/apparatus communication apparatus and methods and is hereby incorporated by reference. In the alternative, the consumer can communicate laundry and dry-clean instructions for an identified item to the service provider or its facilities or its computers directly and the service provider can treat the item accordingly once the identified item is in the service facility.

Services Offered

The customer can transmit a wide array of specific instructions and personal preferences on how to treat each individual item given to the service provider. These can include instructions regarding inspecting, tagging, sorting, pre-treating, fabric softening, wrinkle treating (such as wrinkle prevention, wrinkle resistance, wrinkle removal, and wrinkle reduction), dye release treating, fuzz and pill treating, hue and tone preserving, cleaning, stain removing, deodorizing, sanitizing, water proofing, stain proofing, static proofing, pressing, folding, packaging, dyeing, repairing, altering, refreshing, revitalizing, perfuming, and combinations thereof. Known sorting and folding apparati are disclosed in U.S. Pat. Nos. 4,234,179, 4,238,060, 4,907,699, 4,991,719, 5,125,513, and 5,419,439, and are hereby incorporated by reference. Further, the instructions may be very specific. For example, the customer may specify which perfume to use on one pillowcase and/or how to fold one hand towel.

Another service provided may include exposing the permeable surface items to a lipophilic fluid such as conventional dry cleaning solvents. Preferably, the lipophilic fluid is a linear or cyclic siloxane. More preferably, the lipophilic fluid is selected from the group comprising octamethylcyclotetrasiloxane, decamethylcyclopentasiloxane, dodecamethylcyclohexasiloxane. Most preferably, the lipophilic fluid comprises decamethylcyclopentasiloxane. These siloxane solvents and the processes for using them are known and exemplified by U.S. Pat. Nos. 5,865,852, 5,942,007, 6,042,617, 6,042,618, 6,056,789, 6,059,845, 6,063,135 and 6,086,635, all incorporated herein by reference. Also, the processes are licensable from GreenEarth Cleaning LLP in LeeWood, Kans.

Other services and treatments will be apparent to the customer, dry-cleaning professional, and laundry professional.

Item Tracking

Due to the wide array of items accepted and the wide array of services offered, the items may require numerous sorts and separations. U.S. Pat. Nos. 5,794,213, 5,962,834, 5,964,354, and 6,014,628, describe various tagging, sorting, and tracking methods, systems, and apparati, and are hereby incorporated by reference. To further complicate matters, items from many different customers may be commingled to the extent they require similar services. As such, a means to identify an item, its owner, and the specific instructions and personal preferences associated with the item is needed.

This means can be an identification tag affixed to each item. Further, this means can take the form of a UPC bar code, an electronic tag, or a radio frequency device. The identification tag may either be used to store the specific item information or serve as a link to a place in a database containing the item's information. Preferably, for ease of service customization when the item is not in the customer's possession (e.g. when the service provider already has it), the identification tag is linked to a number contained in a database that stores the item's information.

In this manner, the customer can retrieve the item's information from the database by entering the tag code into the database and by adding or editing instructions for the particular item even after the item has been picked up for service. U.S. Pat. No. 5,785,181 describes a method and apparati for linking a tagged item to a computer database, and is hereby incorporated by reference. This will provide a tremendous benefit to customers. For example, a customer finds out that they will be traveling after their shirts have been picked up but before they have been serviced. The customer can transmit to the service provider the instruction to fold the shirts instead of hanging them.

Having described the invention in detail with reference to preferred embodiments, it will be clear to those skilled in the art that various changes and modifications may be made without departing from the scope of the invention and the invention is not to be considered limited to what is described in the Specification.

What is claimed is:

1. A method for treating permeable surface items according to item owner's instructions and personal preferences comprising transmitting said instructions and personal preferences for said permeable surface items to a service provider such that said service provider treats said permeable surface items according to item owner's instructions and personal preferences.

2. A method according to claim 1 wherein said permeable surface items are constructed from materials selected from the group consisting essentially of cotton, polyester, nylon, rayon, silk, wool, spandex, leather, canvas, natural fur, synthetic fur, and mixtures or combinations thereof.

3. A method according to claim 1 wherein permeable surface items are selected from the group consisting essentially of beach towels, bath towels, hand towels, washcloths, and bathrobes.

4. A method according to claim 1 wherein said permeable surface items are selected from the group consisting essentially of bed sheets, pillowcases, bed covers, mattress pads, pillows, comforters, blankets, curtains, draperies, and dining table linens.

5. A method according to claim 1 wherein said permeable surface items are selected from the group consisting essentially of shirts, blouses, pants, skirts, suits, dresses, sweaters, jeans, coats, jackets, blazers, under garments, socks, hosiery, and shoes.

6. A method according to claim 1 wherein said item owner's instructions and personal preferences are selected from the group consisting essentially of inspecting, tagging, sorting, pre-treating, fabric softening, wrinkle treating, dye release treating, fuzz and pill treating, hue and tone preserving, cleaning, stain removing, deodorizing, sanitizing, water proofing, stain proofing, static proofing, pressing, folding, packaging, dyeing, repairing, altering, refreshing, revitalizing, perfuming, and combinations thereof.

7. A method according to claim 1 wherein said service provider treats said permeable surface items by one or more treatment steps comprising exposing said permeable surface items to a lipophilic fluid.

8. A method according to claim 7 wherein said lipophilic fluid comprises a linear siloxane, a cyclic siloxane, or mixtures thereof.

9. A method according to claim 8 wherein said lipophilic fluid comprises octamethylcyclotetrasiloxane, decamethylcyclopentasiloxane, dodecamethylcyclohexasiloxane, or mixtures thereof.

10. A method according to claim 9 wherein said lipophilic fluid comprises decamethylcyclopentasiloxane.

11. A method according to claim 9 wherein said lipophilic fluid comprises decamethylcyclopentasiloxane and is substantially free of octamethylcyclotetrasiloxane.

12. A system for treating permeable surface items according to item owner's instructions and personal preferences comprising a means for item owner to transmit said instructions and personal preferences for said permeable surface items to a service provider such that said service provider treats said permeable surface items according to item owner's instructions and personal preferences.

13. A system according to claim 12 wherein said item owner's instructions and personal preferences are associated with an identification tag affixed to said permeable surface item.

14. A system according to claim 13 wherein said identification tag contains a UPC bar code.

15. A system according to claim 13 wherein said identification tag is an electronic tag.

16. A system according to claim 13 wherein said identification tag is a radio frequency device.

17. A system according to claim 12 wherein the means for transmitting is discrete from said service provider.

18. A system according to claim 12 wherein the means for transmitting is via telephone line.

19. A system according to claim 12 wherein the means for transmitting is via local access network line.

20. A system according to claim 12 wherein the means for transmitting is via cable line.

21. A system according to claim 12 wherein the means for transmitting is via satellite.

22. A system according to claim 12 wherein the means for transmitting is via computer.

23. A system according to claim 12 wherein the means for transmitting is via Internet.

24. A system according to claim 12 wherein the means for transmitting is via telecommunications device.

25. A system according to claim 12 wherein the means for transmitting is via letter mail.

26. A system according to claim 12 wherein the means for transmitting is via electronic mail.
